(19) United States
(12) Patent Application Publication
(10) Pub. No.: US 2021/0235221 A1
(43) Pub. Date: Jul. 29, 2021

(54) HOME INDICATOR SYSTEM

(71) Applicant: Vandi Cooyar, Walnut Creek, CA (US)

(72) Inventor: Vandi Cooyar, Walnut Creek, CA (US)

(21) Appl. No.: 16/931,084

(22) Filed: Jul. 16, 2020

Related U.S. Application Data
(60) Provisional application No. 62/861,136, filed on Jun. 13, 2019.

(51) Int. Cl. H04W 4/02; H04L 29/08; F21V 23/04

(52) U.S. Cl. CPC H04W 4/023; H04L 67/12; F21Y 2115/10; F21V 23/0407; H04L 67/104

(57) ABSTRACT

A system and method for receiving at a server operational information from a remote device, said operational information including a request to activate an indicator at a specific location and transmitting to a hub, a signal to activate the indicator at the specific location, wherein said hub is coupled to a remote unit, said remote unit operable to control the indicator. The server may present an application programming interface (API) to a network and API is further operable to present controls for either a visual indicator, an audio indicator, or a combination thereof. The indicator is disposed to be visible from either a street or from the sky and operated in response to a GPS indication from a vehicle.

### PRIORITY

This application claims the benefit of Provisional Patent application 62/861,136 by the same inventor, which is incorporated by reference as if fully set forth herein.

### BACKGROUND

Emergency responders often require more than just an address to locate a person in need. Many times, finding the address of a home or apartment, condominium etc. is difficult because the address sign is missing or hidden behind a parked car or there are no street lights or exterior house lights on to allow the sign to be visible. Over the years different approaches to solving this problem have been tried, such as painting the house number on the curb or putting the house number on the mailbox.

Unfortunately, a parked car may hide the number or there may not be a curb at that address or the number might fall off the mailbox. Accordingly, there is a demand for a way to direct emergency responders to the proper location to provide critical services in a quick manner without unnecessary delays so that the first-responders be it Police, Fire or EMT are able to quickly identify the emergency location in a life threatening situation quickly.

Package and Food Delivery as well as Rideshare Drivers and service providers often require more than just an address to locate a home in a timely efficient manner. Many times, finding the address of a home, apartment condominium is difficult because the address sign is missing or hidden behind a parked car or there are no street lights or exterior house lights on to allow the sign to be visible, or GPS systems used by the drivers are not accurate and direct the driver to the wrong address. Over the years different approaches to solving this problem have been tried by delivery systems, from maps to GPS location services. Accordingly, there is a demand for a way to help delivery networks to quickly and efficiently locate the proper delivery location.

Often when having social gatherings it is difficult for attendees to locate the gathering location. Many times, finding the address of a home, apartment condominium is difficult because the address sign is missing or hidden behind a parked car or there are no street lights or exterior house lights on to allow the sign to be visible, or GPS systems used by the attendees are not accurate and direct the individual to the wrong address. Over the years different approaches to solving this problem have been tried by gathering hosts from placing balloons or signs showing the location of the gathering. Accordingly, there is a demand for a way to help hosts of social gatherings to help their attendees to quickly and easily locate the gathering location.

For home or property alarm systems, it is difficult for police to locate the property at which the security system has been triggered. Many times, finding the address of a home, apartment, condominium, commercial building, or commercial suite, is difficult because the address sign is missing or hidden behind a parked car or there are no street lights or exterior house lights on to allow the sign to be visible. Over the years the triggering of an audible alarm has been used with poor location indication due to echo's and the omnidirectional nature of sound. Accordingly, there is a demand for a way to help alarm systems help police quickly and easily locate the triggered Alarm Location. Furthermore, the system will alert neighbors of the users emergency situation.

### BRIEF DESCRIPTION OF THE DRAWINGS

FIG. 1 shows a functional block diagram of a client server system.

FIG. 2 illustrates a diagram of one embodiment according to the current disclosure.

FIG. 3 shows another embodiment of a system according to this disclosure.

### SUMMARY

Disclosed herein are systems and methods for detecting the existence of a call for emergency aid and activating an indicium to aid an emergency responder in finding the location where aid is summoned. The indicium may be sound, lights, strobes, colored lights and the like. Also disclosed herein are systems and methods for assisting delivery networks in identifying a delivery location by activating an indicium to aid delivery drivers in finding the delivery location. The indicium may be sound, lights, strobes, colored lights and the like.

Further disclosed herein are systems and methods for assisting social gathering attendees in identifying a delivery location by activating an indicium to aid an attendee in finding the gathering location. The indicium may be sound, lights, strobes, colored lights and the like. Also disclosed herein are systems and methods for assisting alarm systems in broadcasting a position-indicating distress signal by activating an indicium to aid a responder in finding the location. The indicium may be sound, lights, strobes, colored lights and the like. This system will both assist First Responders in locating the location of the triggered alarm and will advise neighbors of the emergency situation.

Also disclosed herein is a system and method for receiving at a server operational information from a remote device, said operational information including a request to activate an indicator at a specific location and transmitting to a hub, a signal to activate the indicator at the specific location, wherein said hub is coupled to a remote unit, said remote unit operable to control the indicator. The server may present an application programming interface (API) to a network and API is further operable to present controls for either a visual indicator, an audio indicator, or a combination thereof. The indicator is disposed to be visible from either a street or from the sky and operated in response to a GPS indication from a delivery vehicle.

The construction and method of operation of the invention, however, together with additional objectives and advantages thereof, will be best understood from the following description of specific embodiments when read in connection with the accompanying drawings.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

The term “virtual machine” or “VM” generally refers to a self-contained operating environment that behaves as if it is a separate computer even though it is part of a separate computer or may be virtualized using resources from multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

The terms “Zigbee” or “XBEE” generally refer to an IEEE 802.15.4-based specification for a suite of high-level communication protocols used to create personal area networks with small, low-power digital radios, such as for home automation, medical device data collection, and other low-power low-bandwidth needs, designed for small scale projects which need wireless connection. Hence, Zigbee may form a low-power, low data rate, and close proximity (i.e., personal area) wireless ad hoc network.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters, radio receivers, radio transceivers, wireless transmitters, wireless receivers, wireless transceivers, and handheld personal communication devices such as cellular phones, tablet computers, “smart phones”, digital assistants and the like. Certain embodiments may use wireless communications systems such as optical, laser and the like. Moreover, embodiments may invoice voice-controlled devices such as Amazon's ECHO and Google's HOME system.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device.

The methods and techniques described herein may be performed on a processor-based device. The processor-based device will generally comprise a processor attached to one or more memory devices or other tools for persisting (?) data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters, radio receivers, radio transceivers, wireless transmitters, wireless receivers, wireless transceivers, and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

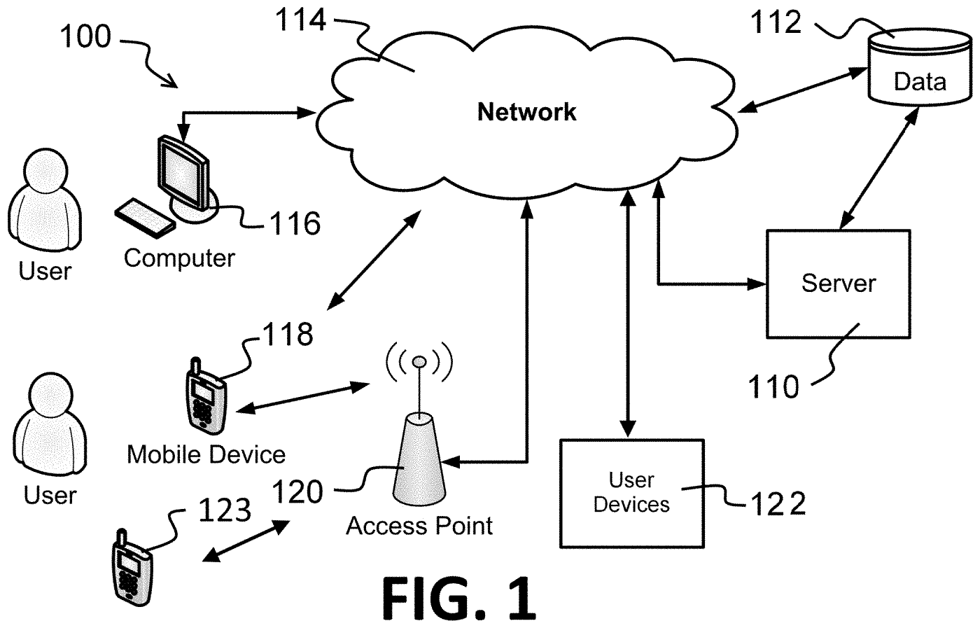

FIG. 1 shows a functional block diagram of a client server system 100 that may be employed for some embodiments according to the current disclosure. In FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively, the user may access the server 110 through the network 114 by using a smart device such as a telephone or PDA 118. The smart device 118 may connect to the server 110 through an access point 120 coupled to the network 114. The mobile device 118 includes a sound capture device such as a microphone

Modernly, home and business telephone systems may employ voice over internet protocol (VOIP) for processing conventional telephony. In these scenarios a local handset 123 is coupled to an access point 120. Often this coupling is done through a hub or phone adapter (not shown) or other hardware to provide control functions to the handset 123. In operation, the telephone 123 appears to a user as a conventional telephone, but instead of using traditional “copper” from the phone company, it is digitized and processed through the facilities internets service provider (ISP) and coupled to the Internet 114 to complete communications. The Internet 114, or a server 110 coupled to the Internet 114 may receive the call and connect with a traditional phone system such as a public switch telephone network (PSTN). User devices 122 may include 3rd party devices, additional wireless transceivers, display indicators such as lights, strobes and alarms and manually operated switches and buttons as need to effectuate the embodiments disclosed herein.

Conventionally, client server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine-readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus, data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Inputs may be any of a number of devices or instruments such as thermometers, pedometers, health measuring devices, transducers, and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

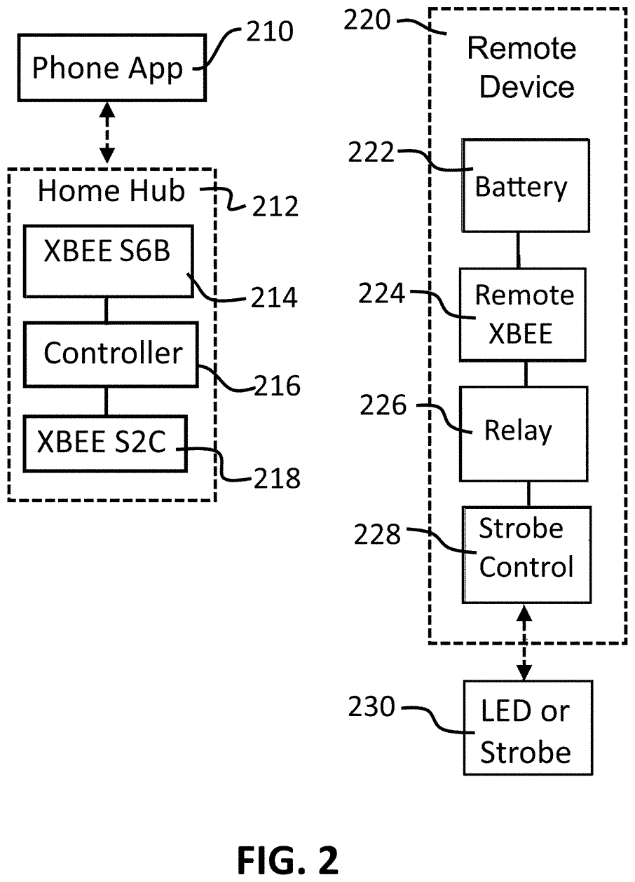

FIG. 2 illustrates a diagram of one embodiment according to the current disclosure. In FIG. 2 a phone application (“app”) 210 is operable to monitor telephone call information including numbers dialed. The phone app 210 is coupled to a home hub 212 such as an access point. This coupling may be wireless through convention means such as Wifi, telephony links, Bluetooth, and the like. The app 210 may have permission to monitor the user's phone dialing/contacts/voice commands, or in some embodiments be a replacement app for the standard phone dialer. For example, and without limitation, the Android framework includes the android.telecom package, which contains classes that help you build a calling app according to the telecom framework. Utilizing these existing services, the app 210 will monitor the users key strokes to detect if a predetermined call, such as an emergency call to 911 is dialed and/or sent. The predetermined number may be any sequence of key strokes. Alternatives to monitoring 911 calls include commercial applications such as RapidSOS Clearinghouse, Apple API, Google API, and the like. These services provide emergency activity information and may be coupled to the system as the phone app. The app 210 may also monitor voice dialing capabilities and wait for a 911 dial. Some embodiments may detect additional or alternative numbers, for example and without limitation, calls to a local security service.

Once the call information is detected, the app 210 will send a digital message to a home hub 212 unit. The home hub unit, which may be integral to a Wifi access point, includes an XBEE Wifi radio transceiver 214 which may be Wifi, cellular or other conventional wireless connection. XBEE is a brand name radio module, but alternative radio models may also be employed in alternative embodiments. Moreover, XBEE and similar modules include both a long range and programmability to effectuate methods disclosed herein. A controller 216 is coupled to the radios 214 and 218. As shown in FIG. 2, the XBEE S6B 214 and XBEE S2C 218 may be employed to receive information to the home hub 212 and to transmit information to a remote device 220. In other embodiments wireless controls similar to XBEE may be employed to effectuate similar results.

The remote device 220 includes a power supply 222 such as a battery or connection to power mains. The power supply 222 powers an XBEE receiver 224 which in turn controls an actuator such as relay 226. The actuator 226 controls the strobe control circuit 228. Separate from the remote device 220 is an indicator 230 such as a strobe light or high intensity LED. The indicator may include other forms of indicia such as sound, color and the like.

The indicator 230 may be separate from the remote device 220 to allow the indicator 230 to be placed outside a structure while the remote device 220 may be inside the structure to protect it from the elements. Moreover, the indicator 230 need not be placed facing a public street but may be directed skyward. This may assist location by presenting an indication for an airborne seeker, for example, and without limitation, a delivery drone may be operated to locate a beacon and drop a package.

### Operation

During operation the app 210 may determine an emergency condition by means of: monitoring keystrokes for a 911 dial, monitoring voice dialing capabilities for 911, or integrating with emergency-response networks from which the app would receive such information of an emergency condition requested by a user. Once received the app 210 may send a digital message to the home hub 212 unit. The WIFI module 214 may send a discrete digital signal to an input on the XBEE s2c radio 218 which may receive this as a discrete digital input. Once this is done the XBEE s2c 218 in the HUB may relay that signal to the remote XBEE 224. The remote device 220 will then send a discrete digital output to the relay 226 to activate the LED or strobe tube flasher control 228, which, in turn, activates a strobe or flasher 230 indicating an emergency condition was triggered. In some embodiments like voice over IP (VOIP) embodiments, software may be added to an access point or other telephone system to monitor for a 911 call.

In alternative embodiments, where a Wi-Fi signal is available at the remote device 220 the home hub 212 unit may be eliminated such that the Wi-Fi communications module will be mounted inside the remote device 220 to signal the activate the indicator. Alternative embodiments may also include a “push button” actuator located in the home for turning on the indicator directly.

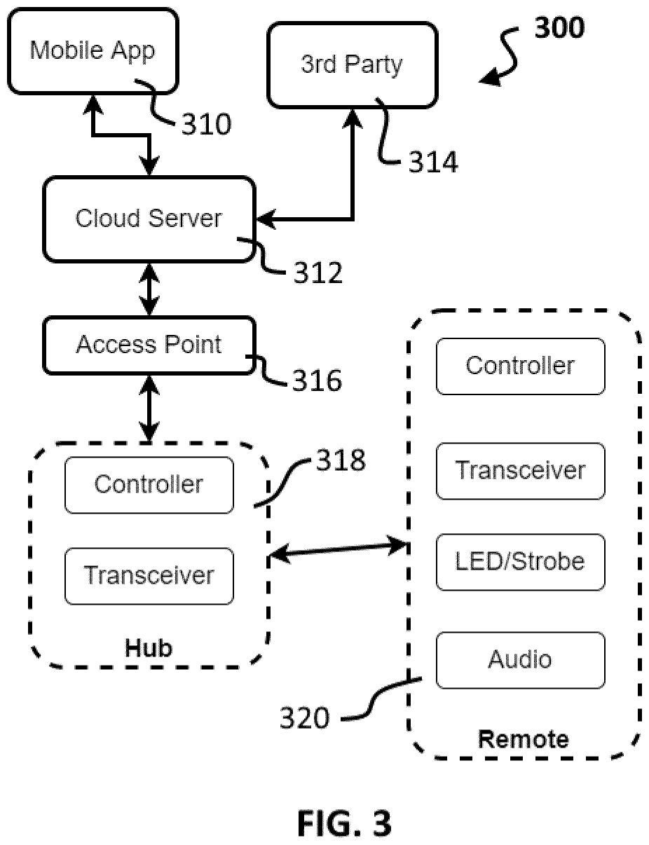

FIG. 3 shows another embodiment of a system 300 according to this disclosure. In FIG. 3 a mobile application 310 which may reside on a portable processing device such as a cell phone is wirelessly coupled to a cloud-based server 312. Other, 3^{rd} party applications 314 may also be coupled to the cloud-based server 312 wirelessly or otherwise.

An access point 316 is coupled to the cloud server 316 and also coupled to a hub 318. the hub 318 includes a processor for processing program instructions and a transceiver for wirelessly coupling to a remote device 320. The remote device 320 may include a processor, a transceiver, and indicators (a strobe light and an audio device). The processor may be coupled to the indicators or two power supplies for the indicators allowing the processor to control the indicators. Conventionally available hardware modules such as the Raspberry PI and Arduino devices may include sufficient hardware to effectuate most of the elements described herein. Indicator drivers may be constructed to transform digital signals into analog control and audio signals. Flashers, LEDs and strobes are conventionally available as well. The cloud server 316 may receive operational information from the 3^{rd} party 314 or from a mobile device 310.

Certain embodiments may combine the hub and the remote unit to a single unit. In this embodiment the combined unit may be coupled directly to the access point and operate under the control of the cloud server. In these embodiments the indicator, such as the strobe, may be integrated into the unit, or removable so that it may be positioned at a distance.

### Non-Emergency Use

The system of FIG. 3, may be employed for non-emergency use such as for delivery of goods and services or for generally indicating a location. The cloud server 312 may expose to the public through an application programming interface (API) or other means controls to operate the system. These controls may allow for 3^{rd} parties to control the operation of a strobe or audio signal located on the remote device 320. In addition, the mobile app 310 may effectuate similar operations through an exposed API.

In operation the hub 318 may be located in a facility and coupled to a remote device 320 through their respective transceivers. The transceivers may be RF, light, cable or similar systems to effectuate a communications link. Once linked, the hub 318 may send controls to the remote 320 instructing it to operate a beacon such as a strobe, an LED, an audio (sound) device or other indicating devices.

By exposing control of the remote through the cloud-based server 312 any 3rd party 314 software process can access the API and send instructions. For example, and without limitation, a delivery network such as FedEx, Amazon, and the U.S. Postal service may be given access to the API. Once a delivery driver's vehicle is within a predetermined distance of the delivery location, the delivery service's operation software or global positioning system may connect to the server 312. The server 312 may then send a message to the hub 318 to trigger the beacon on the remote 320 for the delivery person to see. The beacon may flash a designated color for different companies or may flash white in some embodiments.

Similarly, a social gathering may be indicated. For example, and without limitation, a social gathering organizer may provide an invite through a mobile app 310 to attendees who also access to the server 312. Once the attendees are within a predetermined distance, the beacon will be triggered and begin to flash indicating where the social gather is to occur. To effectuate this embodiment social networking applications would encode access to the server's 312 API into their social networking application.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A system for operating an indicator including:
a telephone module operative to monitor a sequence of keystrokes to detect a call for a pre-determined number, said telephone communicably coupled to a hub;
a transceiver included in said hub, said transceiver operable to wirelessly signal a remote unit, said remote until coupled to an indicator,
wherein when the pre-determined number sequence of key strokes is dialed the hub directs the remote unit to activate the indicator.

2. The system of claim 1 wherein the indicator is a strobe light.

3. The system of claim 1 wherein the indicator is either a colored light, a flashing light, an LED light or an audible sound.

4. The system of claim 1 wherein the hub is coupled to the remote unit using RF.

5. The system of claim 1 wherein the sequence of keystrokes includes the numbers 911.

6. A method of operating a location indicator including:
receiving at a server operational information from a remote device, said operational information including a request to activate an indicator at a specific location;
transmitting to a hub, a signal to activate the indicator at the specific location, wherein said hub is coupled to a remote unit, said remote unit operable to control the indicator.

7. The method of claim 6 wherein the server is coupled to a network and the server has processor-readable, non-transitory instructions directing the server to present an application programming interface (API) to the network.

8. The method of claim 7 wherein the API is further operable to present controls for either a visual indicator, an audio indicator, or a combination thereof.

9. The method of claim 6 wherein the indicator is disposed to be visible from either a street or from the sky.

10. The method of claim 9 wherein the operation information is provided to the server in response to a GPS position indication.

11. The method of claim 10 wherein the GPS position indication is supplied from a vehicle.

12. One or more processor-readable memory devices encoded with processor instructions directing one or more processors to perform a method including:
receiving at a server operational information from a remote device, said operational information including a request to activate an indicator at a specific location;
transmitting to a hub, a signal to activate the indicator at the specific location, wherein said hub is coupled to a remote unit, said remote unit operable to control the indicator

13. The device of claim 12 wherein the server is presents an application programming interface (API) to a network.

14. The device of claim 13 wherein the API is further operable to present controls for either a visual indicator, an audio indicator, or a combination thereof.

15. The device of claim 12 wherein the indicator is disposed to be visible from either a street or from the sky.

16. The device of claim 12 the operation information is provided to the server in response to a GPS position indication.

17. The device of claim 12 wherein the GPS position indication is supplied from a vehicle.
